(19) United States
(12) Patent Application Publication
(10) Pub. No.: US 2026/0099795 A1
(43) Pub. Date: Apr. 9, 2026

(54) SYSTEM AND A METHOD FOR MEASURING NET GAIN AND LOSS OF ALTERNATIVES FOR UNCERSTAIN EVENTS

(71) Applicant: ERNEST FORMAN, BOYNTON BEACH, FL (US)

(72) Inventor: ERNEST FORMAN, BOYNTON BEACH, FL (US)

(21) Appl. No.: 18/822,155

(22) Filed: Aug. 31, 2024

Related U.S. Application Data
(60) Provisional application No. 63/536,385, filed on Sep. 2, 2023.

(51) Int. Cl. G06Q 10/0635; G06N 7/01

(52) U.S. Cl. CPC G06Q 10/0635; G06N 7/01

(57) ABSTRACT

Disclosed is a system for measuring net gain and loss of alternatives dependent on uncertain events. The system includes instructions having steps to receive at least one uncertain event, a list of alternatives, a list of objectives, a list of certain events, and followed by a step to select type of ratio scale measures. The instructions receive relation of alternatives and the certain events, and receives evaluation of likelihoods of certain events for at least one alternative, receives rating of consequences of certain events with respect to at least one objective for at least one alternative, and concluding the step to perform the Monte Carlo simulations on the evaluated likelihoods and consequences to display an expected loss or gain of each alternative on the display unit.

### CROSS-REFERENCE TO RELATED APPLICATIONS

This application claims the benefit of U.S. Provisional Application No. 63/536,385 filed on Sep. 2, 2023, the entirety of which is hereby incorporated by reference.

### BACKGROUND OF THE INVENTION

### 1. Field of the Invention

The invention generally relates to a system for measuring risk and rewards of alternatives, and more particularly relates to a system for measuring net gain and loss of alternatives for uncertain events.

### 2. Description of Related Art

People often have to make decisions under uncertainty-that is, in situations where the probabilities of obtaining a payoff are unknown or at least difficult to ascertain. One solution to this problem is to infer the probability from the magnitude of the potential payoff and thus exploit the inverse relationship between payoffs and probabilities that occurs in many domains in the environment.

Here, we investigated how the mind may implement such a solution: (1) Do people learn about risk-reward relationships from the environment—and if so, how? (2) How do learned risk-reward relationships impact preferences in decision-making under uncertainty?

Risks and Rewards are uncertain events that have negative and positive consequences respectively. It is commonly understood that for any alternative the greater the reward, the greater the risk and the greater the risk the greater the reward. Participants can learn risk-reward relationships from being exposed to choice environments with a negative, positive, or uncorrelated risk-reward relationship. They were able to learn the associations both from gambles with explicitly stated payoffs and probabilities.

The prevalent scientific approach to dealing with uncertainty is to estimate how probability is distributed over the range of possible values of the uncertain variable of interest. The relationship between Probability and an uncertain variable is called a probability distribution.

In subsequent decisions under uncertainty, participants often exploited the learned association by inferring probabilities from the magnitudes of the payoffs. This inference systematically influenced their preferences under uncertainty: Participants who had been exposed to a negative risk-reward relationship tended to prefer the uncertain option over a smaller sure option for low payoffs, but not for high payoffs.

The uncertainty about each of the alternatives under consideration is represented by uncertain events that may or may not occur and if they occur, will have some consequences to one or more of the objectives under consideration. This pattern reversed in the positive condition and disappeared in the uncorrelated condition.

Therefore, there is a need of a system for measuring net gain and loss of alternatives for uncertain events. The system should incorporate probability distributions, Monte Carlo simulations, and perform tradeoffs to measure net gain and loss of alternative courses of action for uncertain events.

### SUMMARY OF THE INVENTION

In accordance with teachings of the present invention a system for evaluating expected annual returns for writing covered call options, is provided.

An object of the present invention is to provide a system for measuring net gain and loss of alternatives from events. The system includes an input unit, a database, a processing unit, and a display unit. The database is configured to store instructions and Monte Carlo simulation model. The processing unit is connected with the input unit and the database for processing the stored instructions. Further, the processing unit processes the Monte Carlo simulation model.

The display unit is coupled to the processing unit for displaying the processed instructions via a graphical user interface. The instructions start with receiving via the input unit at least one uncertain event, a list of alternatives, a list of objectives, a list of certain events, and followed by a step to select type of ratio scale measures.

Further, the instructions receive relation of alternatives and the certain events, and receives evaluation of likelihoods of certain events for at least one alternative, receives rating of consequences of certain events with respect to at least one objective for at least one alternative, and concluding the step to perform the Monte Carlo simulations on the evaluated likelihoods and consequences to display an expected loss or gain of each alternative on the display unit.

Another object of the present invention is to provide instructions with a step to display a via a graphical user interface a loss exceedance curve for each alternative. Further, the instructions include a step to display a graphical user interface a gain exceedance curve for each alternative. Furthermore, the instructions display a net gain/loss exceedance curve for each alternative.

Another object of the present invention is to provide pairwise comparisons of a range of percentages of likelihoods and consequences of the uncertain event as a ratio scale measure. Further, the instructions include a step to receive a value of risk (VAR) of interest for the loss or gain from the alternative.

Another object of the present invention is to provide a step to display a chance of exceeding the user specified the value of risk of interest for loss or gain. Further, instructions include a step to apply an artificial intelligence model to identify relevant alternatives, objectives and certain events.

While a number of features are described herein with respect to embodiments of the inventions; features described with respect to a given embodiment also may be employed in connection with other embodiments. The following description and the annexed drawings set forth certain illustrative embodiments of the inventions. These embodiments are indicative, however, of but a few of the various ways in which the principles of the inventions may be employed. Other objects, advantages, and novel features according to aspects of the inventions will become apparent from the following detailed description when considered in conjunction with the drawings.

### BRIEF DESCRIPTION OF DRAWINGS

The annexed drawings, which are not necessarily to scale, show various aspects of the inventions in which similar reference numerals are used to indicate the same or similar parts in the various views.

FIG. 1 illustrates a block diagram of a system for measuring net gain and loss of alternatives from events;

FIG. 2 illustrates a screenshot of a graphical user interface showing a relation of the alternatives and certain events, in an exemplary embodiment;

FIG. 3 illustrates a screenshot of a graphical user interface showing evaluation of likelihoods of certain events with an alternative, in an exemplary embodiment;

FIG. 4 illustrates a screenshot of a graphical user interface showing evaluation of consequences of certain events with an alternative, in an exemplary embodiment;

FIG. 5A illustrates a screenshot of a graphical user interface showing expected loss or gain of an alternative, in an exemplary embodiment;

FIG. 5B is a continuation of the graphical user interface from FIG. 5A;

FIG. 6 illustrates a screenshot of a graphical user interface showing receiving of value of risk;

FIG. 7 illustrates a screenshot of a graphical user interface showing net gain/loss exceedance curve for each alternative, in an exemplary embodiment; and

FIG. 8 illustrates a screenshot of a graphical user interface showing gain exceedance for Bioenergy Alternative.

### DETAILED DESCRIPTION OF DRAWINGS

The present disclosure is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

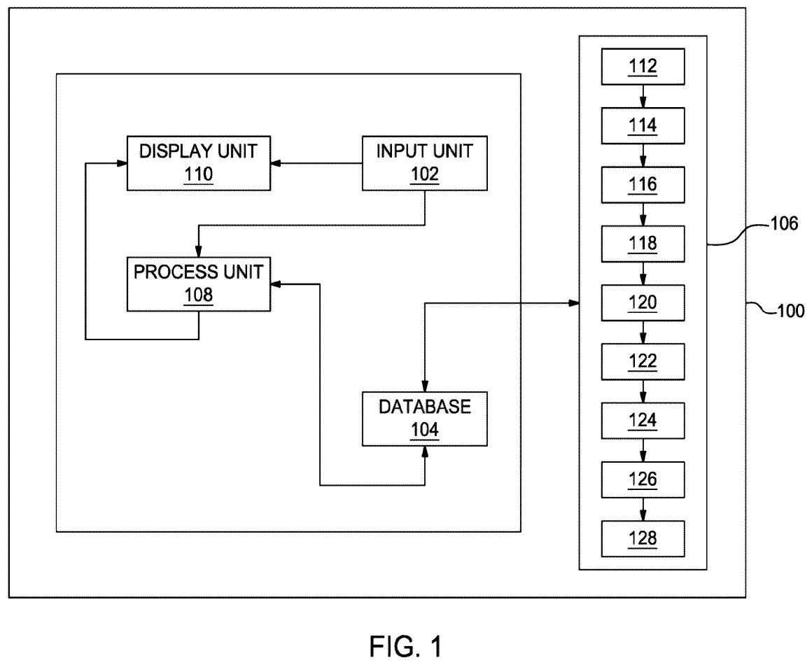

FIG. 1 illustrates a block diagram of a system 100 for measuring net gain and loss of alternatives from events. The system 100 includes an input unit 102, a database 104 for storing instructions 106 and a Monte Carlo Simulation model, a processing unit 108, and a display unit 110.

The input unit 102 allows a user to enter commands to be processed by the processing unit 108. Examples of the input unit 102 include but not limited to a mouse, keyboard, joystick, interactive pen, touch-display, etc. The database 104 stores instructions 106. Examples of the database 104 include but not limited to a RDBMS, NoSQL, Hierarchical, Network and OODBMS.

The processing unit 108 is connected with the input unit 102 and the database 104 for processing the stored instructions, and the Monte Carlo Simulation model. Examples of the processing unit 108 include but not limited to a controller, microcontroller, SQL, server.

The display unit 110 is coupled to the processing unit 108 for displaying the processed instructions via a graphical user interface. Examples of the display unit 110 include but not limited to a LCD, LED, OLED, or any other electronic display units for displaying the processed instructions.

The instructions initiates with a step 112 of receiving at least one uncertain event via the input unit 102. It would be readily apparent to those skilled in the art that various uncertain events may be envisioned without deviating from the scope of the present invention. However, the system 100 is explained in the specification using an exemplary uncertain event i.e. Renewable Energy Sources for the State of California.

The step 112 is then followed by a step 114 of receiving via the input unit 102, a list of alternatives related to the uncertain event. Examples of the alternatives associated with the Renewable Energy uncertain event include but not limited to Solar Energy, Wind Energy, Bioenergy, Hydropower and Geothermal. It would be readily apparent to those skilled in the art that various types of alternatives related to the uncertain event may be envisioned without deviating from the scope of the present invention.

The step 114 is then followed by a step 116 of receiving via the input unit 102, a list of objectives associated with the alternatives. Examples of the objectives associated with Renewable Energy alternatives include but not limited to Reduce Greenhouse Gas Emissions, Increase Economic Development, Increase Energy Security, and Produce Energy. It would be readily apparent to those skilled in the art that various types of objectives associated with alternatives and uncertain event, may be envisioned without deviating from the scope of the present invention.

The step 116 is then followed by a step 118 of receiving via the input unit, a list of certain events associated with the objectives. Examples of the certain events associated with objectives, alternatives include but not limited to lack of resource availability, diversity energy supply, creation of jobs, etc. It would be readily apparent to those skilled in the art that various types of certain events associated with alternatives, objectives and uncertain event, may be envisioned without deviating from the scope of the present invention.

The step 118 is then followed by a step 120 of selecting via the input unit 102, type of ratio scale measures to measure likelihoods and consequences of the uncertain event. Examples of the ratio scale measures include but not limited to rating scale, step function, utility curve, probabilities derived with pairwise comparisons, PERT Distribution, etc. Probabilities for Risk and Reward events are derived by eliciting judgments about likelihood and consequences of the certain events from one or more users.

The step 120 is then followed by a step 122 of receiving via the input unit 102, relation of the alternatives and the certain events. The step 122 is then followed by a step 124 receiving via the input unit 102, evaluation of likelihoods of certain events for at least one alternative.

The step 124 is then followed by a step 126 of receiving via the input unit 102, evaluation of consequences of certain events for at least one alternative. The step 126 is then followed by a step 128 of performing the Monte Carlo simulations on the evaluated likelihoods and consequences to display an expected loss or gain of each alternative on the display unit 110.

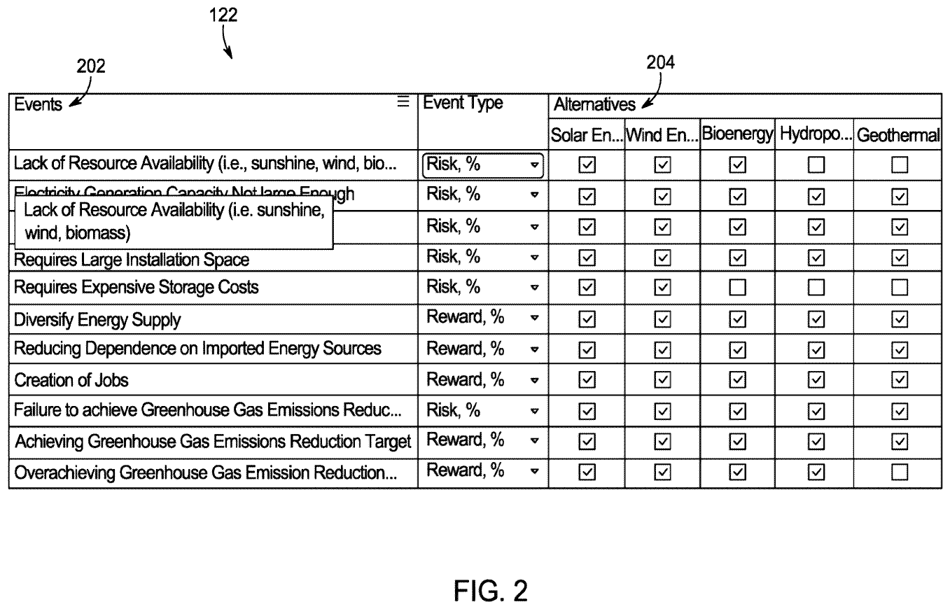

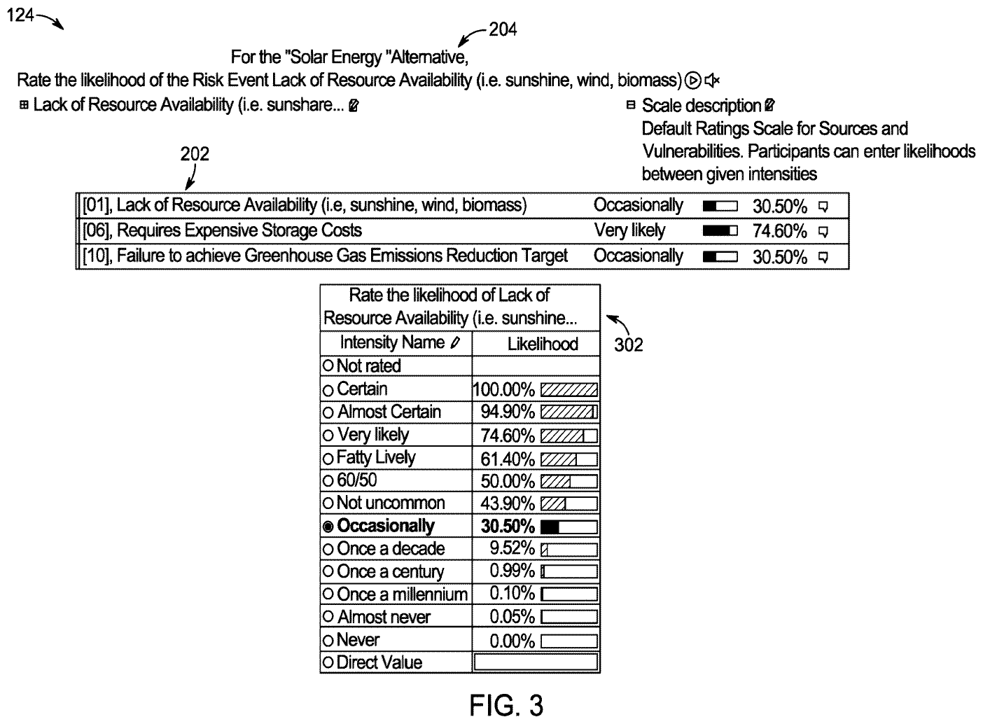

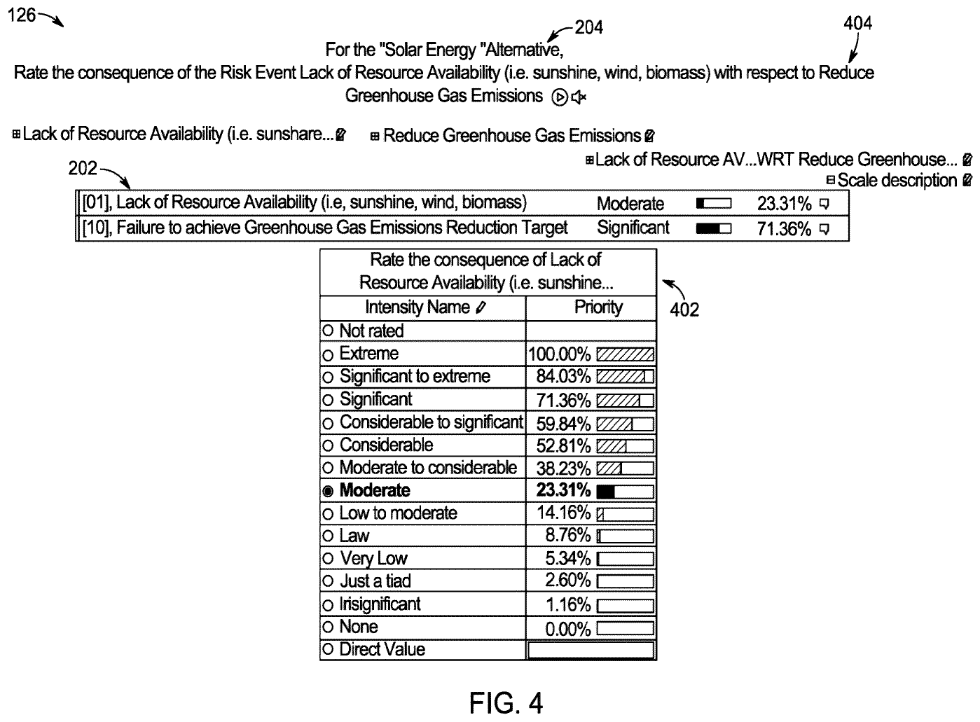

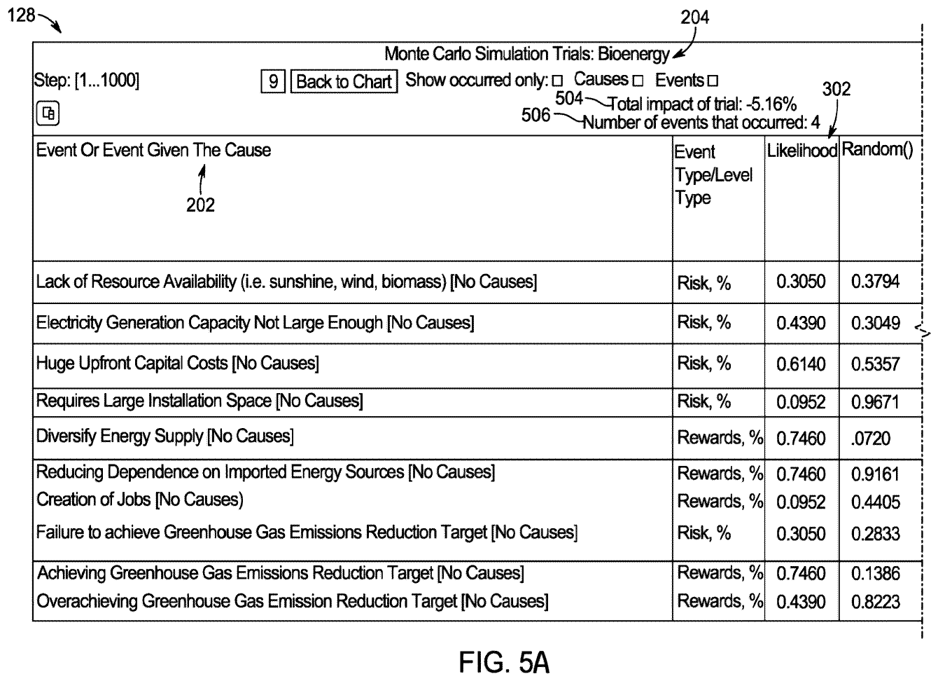

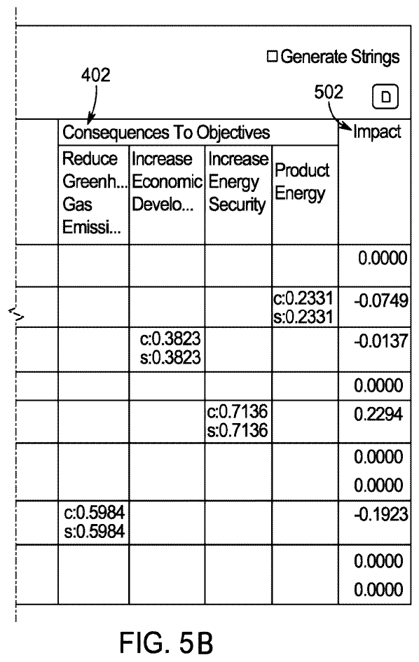

The steps 122, 124, 126, 128 are explained in detail in conjunction with FIG. 2, FIG. 3, FIG. 4, FIG. 5A, and FIG. 5B, respectively of the present invention. The alternatives, the objectives and the certain events are explained in detail in conjunction with FIG. 2 to FIG. 4 of the present invention.

FIG. 2 illustrates a screenshot of a graphical user interface of showing a relation of the alternatives and certain events, in an exemplary embodiment. The step 122 allows a user to create a relation between the certain events 202 and the alternatives 204. For exemplary purposes as shown in FIG. 2, the lack of resource availability (i.e. sunshine, wind, biomass) is associated with alternatives 204 like solar energy, wind energy, and bioenergy, and diversity energy supply is associated with each alternative 204. Similarly, each certain event is associated with each alternative.

FIG. 3 illustrates a screenshot of a graphical user interface showing evaluation of likelihoods of certain events with an alternative, in an exemplary embodiment. The step 124 shows evaluation of likelihoods 302 of certain events 202 with an alternative 204. As shown in FIG. 3, the Solar Energy alternative 204 is evaluated with Lack of Resource Availability certain event 202. The rate of likelihood 302 is evaluated as Occasionally. Similarly, other alternatives 204 are evaluated against the certain events 202.

The step 124 allows the user to rate the likelihood 302 as either Certain, Almost Certain, Very Likely, Fairly Likely, Occasionally, Once a decade, Once a century, etc. Further, the likelihood of Certain is 100%, Almost Certain is 94.90%, Occasionally is 30.50%, etc. It would be readily apparent to those skilled in the art that various names and associated % may be envisioned without deviating from the scope of the present invention.

FIG. 4 illustrates a screenshot of a graphical user interface showing evaluation of consequences of certain events with an alternative, in an exemplary embodiment. The step 126 shows evaluation of consequences 402 of certain events 202 with respect to the objective 404 for an alternative 204.

As shown in FIG. 4, the Solar Energy alternative 204 is evaluated with Lack of Resource Availability certain event 202 with respect to Reduce Greenhouse Gas Emissions objectives 404 for an alternative. The rate of consequences 404 is evaluated as Moderate. Similarly, other alternatives 204 are evaluated against the certain events 202 with respect to other objectives 404.

The step 126 allows the user to rate the consequences 402 as either Extreme, Significant to Extreme, Significant, Considerable, Moderate, etc. Further, the consequence of Extreme is 100%, Significant to Extreme is 84.03%, Significant is 71.36%, etc. It would be readily apparent to those skilled in the art that various names and associated % of consequences 402 may be envisioned without deviating from the scope of the present invention.

FIG. 5A and FIG. 5B illustrate screenshot showing of evaluated likelihoods 302 and consequences to objectives 402 of certain events 202. For exemplary purposes, the step 128 displays one Monte Carlo Simulation Trial for Bioenergy Alternative 204. For Bioenergy Alternative 204, the electricity generation capacity not large enough event 202 has a likelihood of 0.4390 and is larger than the random number generated for this event of 0.3049 thus is deemed to have taken place with a both consequence computed and simulated consequences to the objective ‘Produce Energy’ of c:0.2331, s:0.2331 and an impact 502 of −0.0749.

The Computed consequences does not take into account other events that may take place as well while the Simulated consequence adjusts the consequence to take into account other events that may also take place during the trial. Similarly, the likelihood 302, consequence to objectives 402 and the impact 502 for each event 202 is provided.

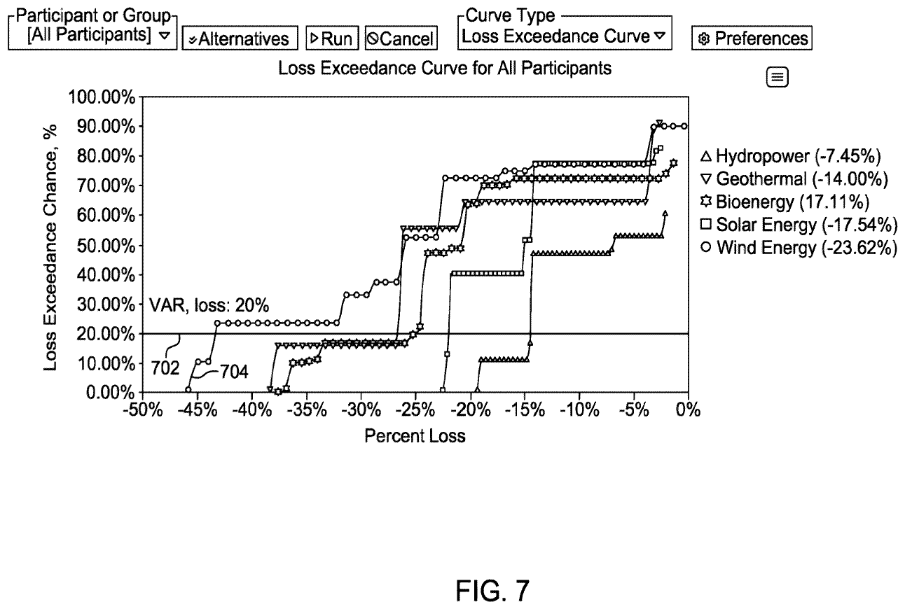

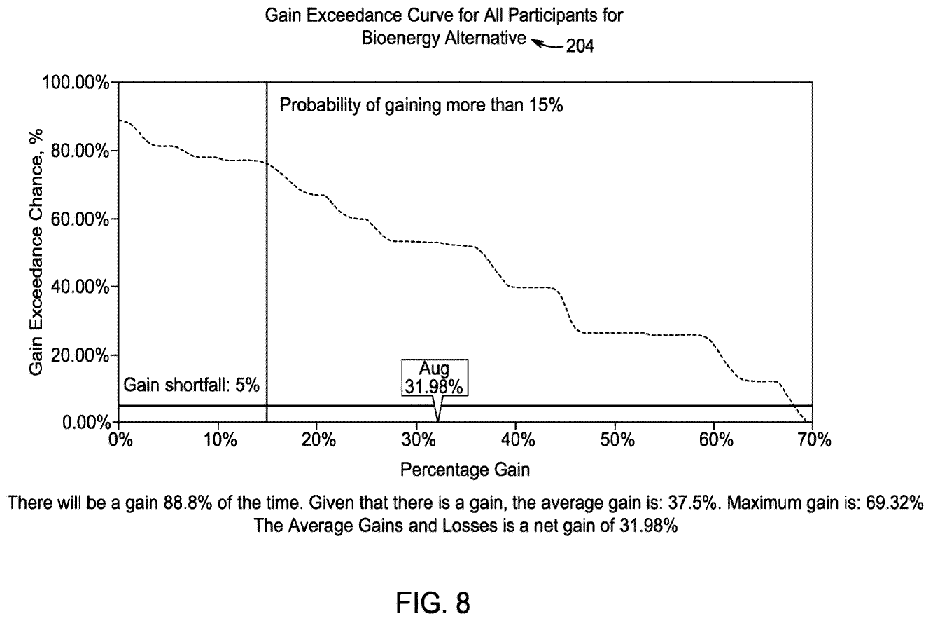

Further, the step 128 displays a total impact of trial 504 and number of events that occurred 506. For exemplary purposes as shown in FIG. 5, the total impact of trial 504 is −5.16%, and number of events that occurred 506 is 4. The total impact of trial 504 displays risk rewards associated with the alternative. The frequencies of the trial losses and gains are accumulated and is shown in the net gain or loss exceedance curve, as shown in FIG. 7 and FIG. 8 of the present invention.

The Monte Carlo simulations on the evaluated likelihoods and consequences to objectives determine the expected risk-rewards (net gain or loss) for each alternative. Due to the non-linearity of relationships between causes, events, and objectives, Monte Carlo simulations are necessary when calculating the losses and gains.

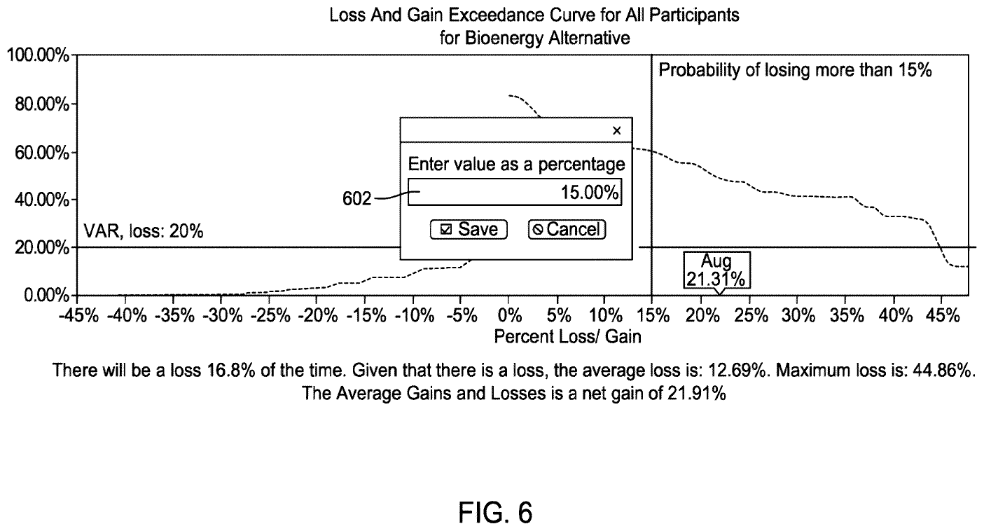

FIG. 6 illustrates a screenshot of a graphical user interface showing receiving a value of risk exceedance for the loss or gain from an alternative of interest to a decision maker 602. For exemplary purposes, the value of risk of interest 602 is 15% for the Bioenergy Alternative 204, representing a decision maker's interest in knowing the likelihood that the alternative's loss will exceed the specified amount. The value of risk of interest 602 is received via the input unit.

Similarly, the value of risk of interest 602 is a predefined parameter to set a benchmark for gain, namely reward. Herein the exemplary, the value of 15% of interest would be 15% gain, or reward. FIG. 7 illustrates a screenshot of a graphical user interface showing loss exceedance curve for all alternatives, in an exemplary embodiment. The net gain or loss is evaluated via the Monte Carlo simulations is displayed via line graph in an exemplary embodiment. It would be readily apparent to those skilled in the art that other types of graphs may also be envisioned without deviating from the scope of the present invention.

In exemplary embodiment, for the value of risk 702 is 20%, the loss exceedance chance for Wind Energy Alternative 704 is 0 to 90%, and percent loss is 46% to 0%. Similarly, the loss exceedance chance and percent loss is displayed for each alternative. It would be readily apparent to those skilled in the art that loss exceedance chance and percent loss for one or more alternatives may be envisioned via graphs without deviating from the scope of the present invention.

FIG. 8 illustrates a screenshot of a graphical user interface showing gain exceedance for Bioenergy Alternative 204. In an exemplary embodiment, the graph is displayed between gain exceedance chance and the percent gain. After the Monte Carlo Simulations, the gain exceedance chance of the Bioenergy Alternative 204 is 88% of the time. Further, the VAR gain shortfall is 5%, and VAR of probability of gaining is more than 15%.

The average gains and losses is a net gain of 31.98%. Similarly, it would be readily apparent to those skilled in the art that the gain exceedance chance and percentage gain may be displayed for other alternatives either in separate graphs or in one graph, without deviating from the scope of the present invention.

For exemplary purposes, what are the risk rewards for closing or opening a school during Covid? These questions are easily answered using the system explained in the present application. The present system takes account of each alternatives, and associated events that may occur, their likelihoods, and consequences to the objectives.

The present invention offers various advantages such as providing a measure of the risk and rewards of alternatives in the face of uncertainty. Further, the present invention incorporates usage of Monte Carlo Simulations Trial to accurately estimate risk and rewards associated with the alternatives.

It should be appreciated that many of the elements discussed in this specification may be implemented in a hardware circuit(s), a circuitry executing software code or instructions which are encoded within computer readable media accessible to the circuitry, or a combination of a hardware circuit(s) and a circuitry or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a circuitry or control block executing code encoded in a computer readable media, or a combination of a hardware circuit(s) and a circuitry and/or control block executing such code.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the inventions have been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the inventions. In addition, while a particular feature of the inventions may have been described above with respect to only one or more of several illustrated embodiments, such feature may be combined with one or more other features of the other embodiments, as may be desired and advantageous for any given or particular application.

1. A system for measuring net gain and loss of alternatives from events, the system comprising:
an input unit;
a database for storing instructions and a Monte Carlo simulation model; and
a processing unit connected with the input unit and the database for processing the stored instructions, further the processing unit processes the Monte Carlo simulation model;
a display unit coupled to the processing unit for displaying the processed instructions via a graphical user interface, wherein the instructions comprising:
receiving via the input unit, at least one uncertain event;
receiving via the input unit, a list of alternatives related to the uncertain event;
receiving via the input unit, a list of objectives associated with the alternatives;
receiving via the input unit, a list of certain events associated with the objectives;
selecting via the input unit, type of ratio scale measures to measure likelihoods and consequences of the uncertain event;
receiving via the input unit, relation of the alternatives and the certain events;
receiving via the input unit, evaluation of likelihoods of certain events for at least one alternative;
receiving via the input unit, rating of consequences of certain events with respect to at least one objective for at least one alternative;
performing the Monte Carlo simulations on the evaluated likelihoods and consequences to display an expected loss or gain of each alternative on the display unit.

2. The system according to claim 1, wherein the instructions further comprising a step to display via a graphical user interface a loss exceedance curve for each alternative.

3. The system according to claim 1, wherein the instructions further comprising a step to display via a graphical user interface a gain exceedance curve for each alternative.

4. The system according to claim 1, wherein the instructions further comprising a step to display via a graphical user interface a net gain/loss exceedance curve for each alternative.

5. The system according to claim 1, wherein the instructions further comprising a step to display via a graphical user interface a net gain/loss exceedance curve for all alternatives.

6. The system according to claim 1, wherein the type of ratio scale measures is a pairwise comparison of a range of percentages of likelihoods and consequences of the uncertain event.

7. The system according to claim 1, wherein the instructions further comprising a step to receive a value of risk of interest for the loss or gain from the alternative.

8. The system according to claim 7, wherein instructions further comprising a step to display a chance of exceeding the user specified the value of risk of interest for loss or gain.

9. The system according to claim 1, wherein the instructions further comprises a step of applying an artificial intelligence model to identify relevant alternatives, objectives, and certain events.
